(19) United States
(12) Patent Application Publication
(10) Pub. No.: US 2017/0052773 A1
(43) Pub. Date: Feb. 23, 2017

(54) APPLICATION INSTALLS USING REMOTE APPLICATIONS

(71) Applicant: Google Inc., Mountain View, CA (US)

(72) Inventors: Thomas Deselaers, Zurich (CH); Benoit Boissinot, Zurich (CH)

(21) Appl. No.: 14/827,994

(22) Filed: Aug. 17, 2015

(51) Int. Cl. G06F 9/445; H04L 29/08

(52) U.S. Cl. CPC G06F 8/61; H04L 67/06

(57) ABSTRACT

A system and method that allows a user to begin use or demonstration of a remote application using, for example, a web-based application implementation or cloud-based application emulation and during the use or demonstration, direct the native application of the use or demonstration to be installed on the user device in the background. The system and method may monitor the remote application operation and transfer data associated with the operation to the user device for performing similar operation of the native application on the user device. The application provider may then direct the seamless transition of the application operation from the remote application use or demonstration to the native application operation at the user device.

### BACKGROUND

In the mobile communication and computing arena, users can download and install small specialized applications, or “apps”, to their individual portable computing devices (e.g. smart phones, tablet computers, laptop computers, and the like), such as to perform specific functions or engage in particular activities. Such functions and activities range from playing games and sharing photographs, to banking and finding real estate properties. As used herein, the term application may refer to any type of standalone or Internet connected application, program, or subroutine executed in any layer in the computing environment (e.g. in the operating system, in the middleware layer, or as a top layer application).

Digital distribution markets, advertisement-based application installations and direct links (e.g., “install this app here”) may provide users with opportunities to purchase any number of such applications for their mobile devices. The usual workflow for application search, discovery and purchase, such as to obtain a game application for example, typically begins when a user searches the market with a categorical query of interest (e.g. “action games”), and selects one or more results that are of interest to the user. The user may then analyze the application details, user reviews, screenshots and other related content and, if satisfied, download and install the application to a representative and working state (i.e., by completing a progression through menus, loading screens, account setup, tutorials, and so forth). The user can then test and/or begin using the application and if not satisfied with the results, can either return to the search process to look for alternative applications or stop searching altogether. The user may further implement an optional uninstall step to remove any unneeded or unwanted applications. However, the time required to demonstrate applications in such a manner may be significant due to the time required for application download, overhead installation and in-application setup.

### BRIEF SUMMARY

Implementations of the disclosed subject matter allow a user to begin use or demonstration of an application after finding a desirable application, install the application to the user device during the use or demonstration and upon completion of the installation, transition from the remote application use or demonstration to an operation of the installed application.

To do so, an implementation of the disclosed subject matter may provide an application provider that allows the user to find, select and begin use or demonstration of a remote application using, for example, a web-based application implementation or cloud-based application emulation.

An implementation of the disclosed subject matter may also provide the application provider to direct the native application of the use or demonstration to be installed on the user device in the background during the use or demonstration of the remote application.

An implementation of the disclosed subject matter may also provide the application provider to, when the installation of the native application is sufficiently completed or when the application provider is otherwise instructed, direct the seamless transition from the remote application use or demonstration to the native application operation at the user device.

An implementation of the disclosed subject matter may also provide the application provider to direct the transfer of a database associated with the remote application operation to the user device such that upon user request and/or at a suitable point of execution or screen reload, the user may be seamlessly transitioned from the remote application use or demonstration to the native application operation at the user device.

Accordingly, implementations of the disclosed subject matter may provide means to exchange communications between an application provider and a user device that allows the user to begin use or demonstration of an application using, for example, a web-based application implementation or cloud-based application emulation. During the use or demonstration, the native application of the use or demonstration may be installed on the user device in the background and when the installation of the native application to the user device is sufficiently completed or when the application provider is otherwise instructed, the remote application use or demonstration may be seamlessly transitioned to the native application operation at the user device.

Implementations of the disclosed subject matter may also provide an application provider to exchange communications with a user device that allows the user to begin use or demonstration of an application using, for example, a web-based application implementation or cloud-based application emulation and during the use or demonstration, direct the native application of the use or demonstration to be installed on the user device in the background. When the installation of the native application to the user device is sufficiently completed or when the application provider is otherwise instructed, the application provider may direct the seamless transition of the application from the remote application use or demonstration to the native application operation at the user device.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of the disclosed subject matter. No attempt is made to show structural details in more detail than may be necessary for a fundamental understanding of the disclosed subject matter and various ways in which it may be practiced.

FIG. 1 shows an illustrative system for providing remote application use or demonstration and during the use or demonstration, installing the application on a user device and seamlessly transitioning from the application use or demonstration to operation of the installed application, according to an implementation of the disclosed subject matter.

FIG. 2 is an example user device suitable for implementing embodiments of the presently disclosed subject matter.

FIG. 3 is an illustrative flowchart depicting operations for providing a remote application use or demonstration and during the use or demonstration, installing the application on the user device and seamlessly transitioning from the application use or demonstration to operation of the installed application, according to an implementation of the disclosed subject matter.

### DETAILED DESCRIPTION

Various aspects or features of this disclosure are described with reference to the drawings, wherein like reference numerals are used to refer to like elements throughout. In this specification, numerous specific details are set forth in order to provide a thorough understanding of this disclosure. It should be understood, however, that certain aspects of the disclosure may be practiced without these specific details, or with other methods, components, materials, and so forth. In other instances, well-known structures and devices are shown in block diagram form to facilitate describing the subject disclosure.

As previously disclosed, the time required to demonstrate or test applications in a mobile environment may be significant due to the time required for download, installation and setup. Thus, embodiments disclosed herein may provide systems and methods that provide the ability for a user to begin a remote application use or demonstration and, if the application is satisfactory to the user, quickly and efficiently complete the installation and seamlessly transition the application from the remote application use or demonstration to the native application operation at the user device.

More specifically, described herein are techniques for exchanging communications between an application provider and a user device, which allow the user to begin use or demonstration of an application and direct the native application of the use or demonstration to be installed on the user device in the background. When the installation of the native application is sufficiently completed or when the application provider is otherwise instructed, the application provider may direct the seamless transition of the application from the remote application use or demonstration to the native application operation at the user device. In the following description, for purposes of explanation, numerous examples and specific details are set forth in order to provide a thorough understanding of particular embodiments. Particular embodiments as defined by the claims may include some or all of the features in these examples alone or in combination with other features described below, and may further include modifications and equivalents of the features and concepts described herein.

As previously disclosed, the usual workflow for application search, discovery and purchase typically begins when a user searches the market with a categorical query of interest, selects one or more interesting results, and analyzes the application details, user reviews, screenshots and other related content. If satisfied, the user installs the application to a representative and working state (i.e., completed progression through menus, loading screens, account setup, tutorials, and so forth). Implementations of the disclosed subject matter described herein allow the user to begin use or demonstration of an application while the native application of the use or demonstration is installed on their device, and then seamlessly transition between the remote application use or demonstration and native application operation on the user device, and with that, merge steps for application selection and application installation into a single, transparent step.

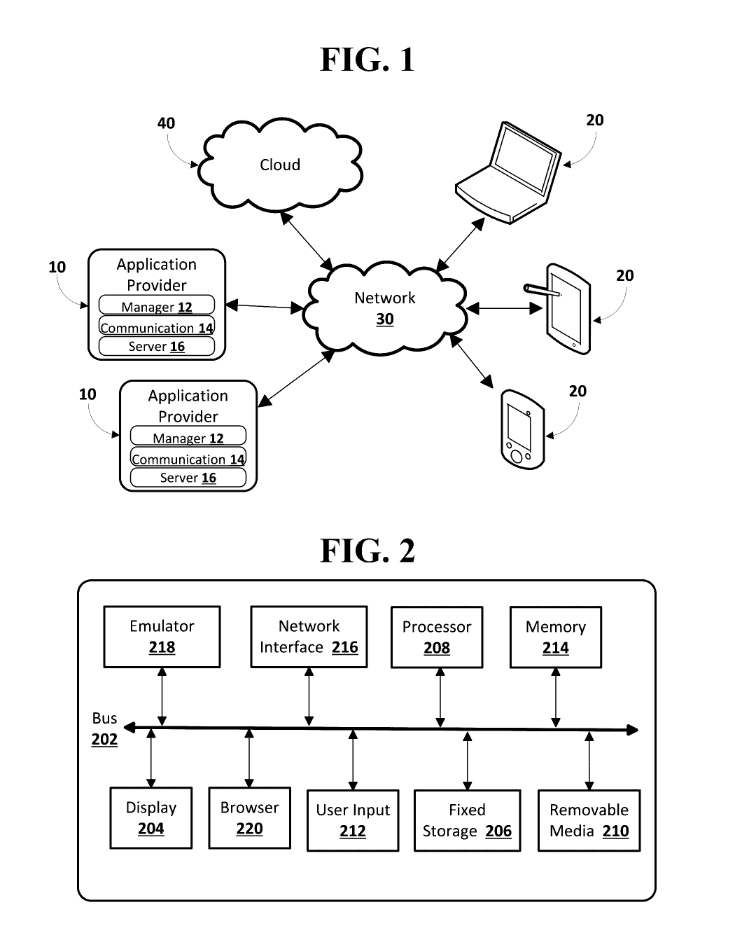

FIG. 1 shows an illustrative system for providing remote application use or demonstration and during the use or demonstration, installing the native application of the use or demonstration on a user device and seamlessly transitioning from the remote application use or demonstration to operation of the installed native application, according to an implementation of the disclosed subject matter. The system of FIG. 1 may include one or more application providers 10, user devices 20 and cloud or cloud-like infrastructures 40 in direct communication or in communication through a network 30. Each application provider 10 may further include a manager 12, communication element 14 and distribution server 16.

The user device 20 may include a smartphone, tablet device, laptop, set-top box, watch, eye-glasses, or other computer system, and may locally execute applications using a local processor and memory. Such memory can include volatile and non-transitory computer readable media in the device. The user device 20 may further include one or more various standardized or specialized user interface devices, such as a touchscreen, keyboard, computer display, voice input and/or recognition device, such as a microphone and/or speaker, camera, keyboard, proximity sensor, mouse, stylus, and so forth, and may further include graphical user interface (GUI) generators for displaying GUIs on each device.

FIG. 2 is an example user device 20 suitable for implementing embodiments of the presently disclosed subject matter. The user device 20 may include a bus 202 which interconnects major components of the user device 20, such as a central processor 208, a memory 214 such as Random Access Memory (RAM), Read Only Memory (ROM), flash RAM, or the like, a user display 204 such as a display screen, a user input interface 212, which may include one or more controllers and associated user input devices such as a keyboard, mouse, touch screen, and the like, a fixed storage 206 such as a hard drive, flash storage, and the like, a removable media component 210 operative to control and receive an optical disk, flash drive, and the like, and a communication element 216 operable to communicate with one or more remote devices via a suitable network connection. Each user device 20 may further include an on-device application emulator 218 and/or browser 220.

The bus 202 allows data communication between the central processor 208 and one or more memory components, which may include RAM, ROM, and other memory, as previously noted. Typically RAM is the main memory into which an operating system and application programs are loaded. A ROM or flash memory component can contain, among other code, the Basic Input-Output system (BIOS) which controls basic hardware operation such as the interaction with peripheral components. Applications resident with the user device 20 may be stored on and accessed via a computer readable medium, such as a hard disk drive (e.g., fixed storage 206), an optical drive, floppy disk, or other storage medium.

The fixed storage 206 may be integral with the user device 20 or may be separate and accessed through other interfaces. The communication element 216 may provide a direct connection to a remote server via a wired or wireless connection, using any suitable technique and protocol as will be readily understood by one of skill in the art, including digital cellular telephone, WiFi, Bluetooth®, near-field, and the like. For example, the communication element 216 may allow the user device 20 to communicate with other devices via one or more local, wide-area, or other communication networks, as described in further detail below.

Returning to FIG. 1, each application provider 10 may be configured to support storage and access to various applications including those stored by the application server 16, licensing and authentication for such access or distribution, and to deploy applications to the user devices 20 as required. When a user wishes to search for a particular application using a user device 20, the user device 20 may establish a communication with the application provider 10 and/or cloud structure 40 that hosts desired applications. The application providers 10 and user devices 20 may be configured to communicate with one another directly or through the network 30 via communication elements 14 and 216 and various types of electronic communication protocols including, but not limited to, Wi-Fi, general packet radio service (GPRS), global system for mobile communications (GSM), enhanced data rates for GSM evolution (EDGE), 3G, 4G, 4G long-term expansion (LTE), worldwide interoperability for microwave access (WiMAX), Ethernet, the Internet, and other wireless and wired electronic communication protocols.

In an implementation of the disclosed subject matter, when the user finds a desired application from those provided by the distribution server 16 of an application provider 10, the manager 12 of the application provider 10 may automatically provide a remote application use or demonstration using, for example, a web-based application implementation or cloud-based application emulation. For example, the manager 12 may offer a remote, interactive application use or demonstration so that users may experience an application and observe how it works with respect to the actual user device 20 without native application installation and associated delays. Such a remote application use or demonstration may illustrate an application function at the actual user device, in comparison to simple illustrative screenshots that may be provided at a website. This way, the users are more likely to buy and use the application. In the following description, the user may begin any type of remote application use and, if the application is satisfactory to the user, complete the installation and seamlessly transition from the remote application use to the native application operation at the user device. For illustration purposes, a remote application demonstration is described in detail, but implementations are not limited thereto.

To provide such a remote application demonstration, the manager 12 of the application provider 10 may create an application domain and hosting environment, and offer the user a remote application demonstration using for example, a web-based application implementation, a cloud-based application emulation or other similar remote application operation. To improve the implementation of the remote application, the application provider 10 may first consider a number of factors to determine an optimal platform to provide the remote application operation. Although the following description distinguishes web-based application implementation from cloud-based application emulation, in general, a web-based application implementation may share a number of features with a cloud-based application emulation, including for example, one or more operations such as data storage performed in cloud or cloud-like infrastructures.

If the manager 12 determines that it is optimal to provide a web-based application implementation to provide the user with the remote application demonstration or determines that there is little, insignificant or avoidable differences between the web-based application implementation and the native version of the application, the manager 12 may provide the user with the remote application demonstration using web-based application implementation. A web-based application may refer to any application program that is accessed for example, over a network connection using HTTP rather than existing on the user device memory, and may be run inside a web browser of the user device. The web-based application implementation demonstration may be created using any number of browser-supported programming languages such that the application demonstration may be run from the web browser 220 of the user device 20.

If the manager 12 determines that there is limited network bandwidth between the user device 20 and the application provider 10, the manager 12 may also provide the user with the remote application demonstration using web-based application implementation since transmitting data, such as the screen content of a native, emulated application may take more bandwidth than a web interface. In each case, the manager 12 can create the web-based application implementation demonstration using any number of browser-supported programming languages such that the application demonstration may be run from the web browser 220 of the user device 20. In other cases or where requested by the user, the manager 12 may provide the user with the remote application demonstration using a cloud-based application emulation.

If the manager 12 determines that it may be optimal to provide a cloud-based application emulation to provide the user with the remote application demonstration, or if a cloud-based application emulation is requested by the user, the manager 12 may provide the user with the remote application demonstration that functions in the cloud with less dependence upon web browsers. To do so, a version of the application may be executed on a remote platform such as a cloud-based hosting system. The cloud-based application emulation may be substantially identical in appearance and user-facing functionality to the native application that may be installed on the user device 20. In the case of a cloud-based application emulation, some data may be stored in cloud or cloud-like infrastructures 40 and/or may be cached locally for offline operation. Further, cloud-based application emulations of the application may support additional user requirements and provide a wider range of features than corresponding web-based application implementations. For example, similar to desktop applications, cloud applications may provide an offline mode, rich user experience and instant responses to user actions. Similar to web-based application implementations, there is no need to install cloud applications on the user device, and updates can be performed at any time by simply uploading a newer version to the cloud 40. The cloud-based application emulation may also store data in the cloud 40. If applicable web-based application implementations or cloud-based application emulations have been previously created or are otherwise available to the manager 12, each may be employed as needed.

In some embodiments, the cloud-based application emulation may be an emulation of the native application. That is, a cloud-based system may execute an emulation system that mimics the execution environment of the user device 20, so that the operation of the application as experienced by the user may be similar to, or indistinguishable from, the equivalent operation of the native application. In still another implementation, the remote application demonstration may be provided directly by a native application operation during the installation in the background. For example, where the remote application demonstration can be quickly and effectively provided by the native application operation, during the installation of the native application in the background, content of the application may be streamed to the user device 20 and fetched on demand to provide the remote application demonstration during the installation of the native application in the background. In this case, no transition from the remote application demonstration to the native application operation is required.

To further improve the implementation of the remote application demonstration, the application provider 10 may limit functionality of the remote application demonstration either in the case of a web-based application implementation or a cloud-based application emulation. The application functions of the remote application demonstration may be limited to accommodate bandwidth and other communication variables between the user devices 20 and the application provider 10 and/or cloud 40. For example, the application functions of the remote application demonstration may be limited to application introductions (e.g., how the user or users may interact with the application), application login flows, application setup and read-only content of the application (e.g., information for a single entity such as, for example, a review page for a restaurant, a Wikipedia page, and so forth). An introduction to the application may include images and text descriptions of application features and series of such images and descriptions to illustrate to a user an operation of the application. Login flows and application setup information may also include images and descriptions of the application to illustrate to a user a login and setup operation of the application.

During the remote application demonstration, the user device 20 may establish a communication with the application provider 10, and the remote application demonstration provided by the application provider 10 may be run from the web browser 220 of the user device 20. In the case of a remote application demonstration using a cloud-based application emulation, the user device 20 may establish a communication with the cloud or cloud-like infrastructures 40 as directed by the application provider 10, and the remote application demonstration may be run from the cloud-based application emulation. The user is then able to experience an operation of the application and observe how the application works with respect to the user device 20. At any time, the user can interrupt the remote application demonstration, resume the remote application demonstration, or terminate the remote application demonstration with or without pursuing other application demonstrations. The user may also advance and/or commence the remote application demonstration from various application states and/or application stages.

While the manager 12 provides the user with the application demonstration, the communication element 14 of the application provider 10 may direct the installation of the native application of the demonstration on the user device 20 in the background, i.e., concurrently with execution of the remote demonstration described above, or otherwise in a manner that does not interrupt the use of the device by the user. In an implementation, the background installation of the native application may include a network data transfer that is initiated by the communication element 14 without explicit input from the user, and may consider data exchange factors such as bandwidth to minimize the impact of the background installation of the native application on the user device 20. In one implementation, a background transfer daemon can be provided and configured to perform background installation of data or content between the communication element 14 of the application provider 10 and the user device 20 on behalf of the application. The communication element 14 may initiate the background installation by identifying the source of the application and destination of the installation, and sending a request to the background transfer daemon to download data between the identified source and destination.

When the background installation process is sufficiently completed (i.e., when the application is loaded to the user device 20 and the data of the application is written to the user devices' memory), the user device 20 may notify the application provider 10 using broadcast or other inter-process communications (e.g., broadcast intents). When the application provider 10 receives such notice or is otherwise instructed, the application demonstration may be transitioned from the remote application operation to the native application operation at the user device. The application demonstration may be automatically, or in response to a user instruction, transitioned from the remote application operation to the native application operation at the user device at a next-occurring suitable point of operation. For example, if the user is viewing introductions to the application in the remote application demonstration at the time of transition, the viewed introductions are seamlessly transitioned from the remote application operation, to substantially the same introductions provided by the native application operation at the user device when a screen is reloaded on the user device 20. If the user is viewing an operation of the application in the remote application demonstration at the time of transition, the viewed operation is seamlessly transitioned from the remote application operation, to substantially the same operation provided by the native application operation at the user device when a screen is reloaded on the user device 20.

The transition from the remote application operation to the native application operation at the user device may be implemented by using, for example, compatible data formats in both the remote application operation and the native application operation at the user device. Data associated with an application operation may be stored in any number of compatible formats (e.g. JSON, XML, or protocol buffers). Accordingly, a database associated with the remote application operation may be stored in the same format as it is later stored on the user device.

The compatible data format allows the application provider 10 to identify, store and transfer data associated with the remote application operation to the user device 20. For example, during the remote application operation, the user device 20 and/or application provider 10 may load content into memory, access external servers for data, read/write data from device storage and perform other functions which reflect the applications' real-time operation. The application provider 10 may monitor the remote application operation and analyze the data associated with the remote application operation in real-time, and store data associated with detected application state, login credentials, user settings such as locale and languages, and screen or other display information associated with the remote application operation.

Once the application provider 10 identifies data associated with the remote application operation in this manner, the communication element 14 of the application provider 10 may then transfer the data associated with the remote application operation to the user device 20 as a binary file and substantially replicate at least a portion of the identified data reflecting the applications' real-time remote operation at the user device 20, for operation of the native application on the user device 20. The application provider 10 may then seamlessly transition the user from the demonstration of the remote application operation to the native application operation on the user device 20. In doing so, the user is seamlessly transitioned from the remote application demonstration, provided by the web-based application implementation or cloud-based application emulation, to an operation of the native application on the user device 20. The user is able to go seamlessly from the remote application demonstration, to the application use at the user device 20, without delay or interruption in the application operation associated with application purchase, installation and/or setup. As noted above, if the user is viewing introductions to the application in the remote application demonstration at the time of transition, the viewed introductions are seamlessly transitioned from the remote application operation, to substantially the same introductions provided by the native application operation at the user device when a screen is reloaded on the user device 20. If the user is viewing an operation of the application in the remote application demonstration at the time of transition, the viewed operation is seamlessly transitioned from the remote application operation, to substantially the same operation provided by the native application operation at the user device when a screen is reloaded on the user device 20.

The compatible data formats may also allow the operation of the native application on the user device 20 to be synchronized with other devices of the same user. For example, data associated with the operation of the native application on the user device 20 may be automatically stored onto cloud storage 40, allowing other devices of the same user to sync to and pull information from the cloud storage 40. In another implementation, the data associated with the operation of the native application on the user device 20 may be pushed across other devices of the same user, such that the user is not required to choose when to sync with the other devices. Each case would allow the user to use the native application on different devices, such as in the case where the user may have the full native application installed on a main mobile device but occasionally uses the application from a desktop computer, laptop computer or other mobile device.

In an implementation, the transition from the remote application demonstration to the native application operation at the user device may be provided with one or more functional expansions or upgrades. For example, the transition from the remote application demonstration to the native application operation at the user device may provide an “upgrade for full experience” command or user input. Upon selection, the user may identify functional expansions or upgrades that are desired and which can be provided by the native application or provided by additional background installation as described above or by foreground installation. In this case, the foreground installation may be initiated by the user and performed upon request, with or without consideration of bandwidth or other data exchange constraints. In one implementation, the upgrades may include the provision of additional applications, including for example, applications related to the demonstrated application.

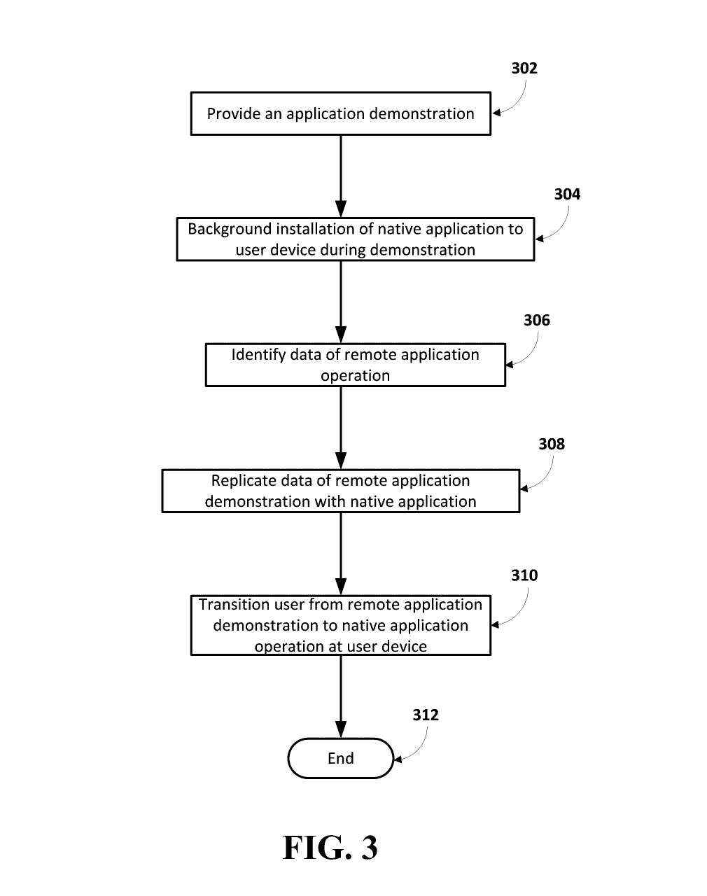

FIG. 3 is an illustrative flowchart depicting operations for providing a remote application demonstration and during demonstration, installing the application of the demonstration to the user device and seamlessly transitioning from the application demonstration to operation of the installed application, according to an implementation of the disclosed subject matter. The described operations may be accomplished using one or more of elements described herein and in some implementations, various operations may be performed in different sequences. In other implementations, additional operations may be performed along with some or all of the operations shown in FIG. 3. In yet other implementations, one or more operations may be performed simultaneously. In yet other implementations, one or more of operations may not be performed. Accordingly, the operations described should not be viewed as limiting.

In step 302, the application provider 10 may exchange communications with a user device 20 that allows the user of the device to view a remote application demonstration using, for example, a web-based application implementation or cloud-based application emulation. When the user finds a desired application, the manager 12 of the application provider 10 may offer a remote, interactive application demonstration so that the user may experience the application and observe how it works with respect to the actual user device 20. To provide the remote demonstration, the manager 12 may determine if it would be optimal to provide a web-based application implementation or a cloud-based application emulation to provide the user with the remote application demonstration. If the manager 12 determines that it would be optimal to provide a web-based application implementation, the manager 12 may create the web-based application implementation demonstration using any number of browser-supported programming languages such that the application demonstration may be run from the web browser 220 of the user device 20. If the manager 12 determines that it would be optimal to provide a cloud-based application emulation, the manager 12 may provide the user with the remote application demonstration that functions in the cloud with less dependence upon web browsers. To do so, a version of the application may be executed on a remote platform such as a cloud-based hosting system. If applicable web-based application implementations or cloud-based application emulations have been previously created or are otherwise available to the manager 12, each may be employed as needed.

In step 304, the communication element 14 may direct the installation of the native application of the demonstration on the user device 20 in the background, i.e., concurrently with execution of the remote demonstration described above, or otherwise in a manner that does not interrupt the use of the device by the user. In an implementation, the background installation of the native application may include a network data transfer that is initiated by the communication element 14 without explicit input from the user and may consider data exchange factors such as bandwidth to minimize the impact of the background installation of the native application on the user device 20. A background transfer daemon can be provided and configured to perform background installation of data or content between the communication element 14 of the application provider 10 and the user device 20 on behalf of the application. The communication element 14 may initiate the background installation by identifying the source of the application and destination of the installation, and sending a request to background transfer daemon to download data between the identified source and destination.

In step 306, the application provider 10 may identify, store and transfer data associated with the remote application operation to the user device 20. During the remote application operation, the user device 20 and/or application provider 10 may load content into memory, access external servers for data, read/write data from device storage and perform other functions which reflect the applications' real-time operation. The application provider 10 may monitor the remote application operation and analyze the data associated with the remote application operation in real-time, and store data associated with detected application state, login credentials, user settings such as locale and languages, and screen or other display information associated with the remote application operation. In step 308, the application provider 10 may transfer the data to the user device 20 as a binary file and substantially replicate at least a portion of the identified data reflecting the applications' real-time remote operation, for operation of the native application on the user device 20.

In step 310, the application provider 10 may, when the background installation of the native application is sufficiently completed (i.e., when the application is loaded to the user device 20 and the data of the application is written to the user devices' memory) or when the application provider 10 is otherwise instructed, transition the application demonstration from the remote application operation to the native application operation at the user device at a next-occurring suitable point of operation. As noted above, if the user is viewing introductions to the application in the remote application demonstration at the time of transition, the viewed introductions are seamlessly transitioned from the remote application operation, to substantially the same introductions provided by the native application operation at the user device when a screen is reloaded on the user device 20. If the user is viewing an operation of the application in the remote application demonstration at the time of transition, the viewed operation is seamlessly transitioned from the remote application operation, to substantially the same operation provided by the native application operation at the user device when a screen is reloaded on the user device 20.

In one implementation, the transition from the remote application operation to the native application operation at the user device may result automatically, such as when the application demonstration exceeds a certain duration or progression state or stage. In this case, the user may be provided with a negative command option to decline the automatic transition prior to reaching the certain duration or progression point. In another implementation, the user may be asked to confirm the transition during but without interruption to the remote application demonstration. In another implementation, the transition from the remote application operation to the native application operation at the user device may result in response to a user command. In each case, the user is able to go seamlessly from the remote application operation to the native application operation at the user device 20, without delay or interruption in the application operation associated with application purchase, download and/or setup. If the user does not agree to the transition or is no longer interested in the remote application demonstration for any reason, the process can be ended at step 312.

The application provider 10 may include, as part of the transition from the remote application operation to the native application operation at the user device, options for one or more application functional expansions or upgrades. For example, the transition from the remote application to the native application operation at the user device may provide an “upgrade for full experience” command or user input and upon selection, the user may identify functional expansions or upgrades which can be provided by the native application or provided by additional background or foreground installation.

In situations in which the systems discussed here collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by the application provider 10. The user may also choose not to participate in any part of the remote application operation, native application installation at the user device, or transition. Where the user wishes to participate, the user can set a device profile to limit the amount and kind of information that is shared with the application provider 10 and other devices. The application provider 10 may also use encryption or similar processes to further ensure privacy, anonymity and security of data regarding each user device 20.

Various implementations of the presently disclosed subject matter may include or be embodied in the form of computer-implemented processes and apparatuses for practicing those processes. Implementations also may be embodied in the form of a computer program product having computer program code containing instructions embodied in non-transitory and/or tangible media, such as hard drives, USB (universal serial bus) drives, or any other machine readable storage medium, such that when the computer program code is loaded into and executed by a computer, the computer becomes an apparatus for practicing implementations of the disclosed subject matter. When implemented on a general-purpose microprocessor, the computer program code may configure the microprocessor to become a special-purpose device, such as by creation of specific logic circuits as specified by the instructions.

The disclosed subject matter may also be implemented using hardware that may include a processor, such as a general purpose microprocessor and/or an Application Specific Integrated Circuit (ASIC) that embodies all or part of the techniques according to the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to the disclosed subject matter.

Moreover, it is to be appreciated that various components described herein can include electrical circuit(s) that can include components and circuitry elements of suitable value in order to implement the embodiments of the subject innovation(s). Furthermore, it can be appreciated that many of the various components can be implemented on one or more integrated circuit (IC) chips. For example, in one embodiment, a set of components can be implemented in a single IC chip. In other embodiments, one or more of respective components are fabricated or implemented on separate IC chips.

The illustrated aspects of the disclosure may also be practiced in distributed computing environments where certain tasks are performed by remote processing devices that are linked through a communications network. In a distributed computing environment, program modules can be located in both local and remote memory storage devices.

What has been described above includes examples of the embodiments of the present invention. It is, of course, not possible to describe every conceivable combination of components or methodologies for purposes of describing the claimed subject matter, but it is to be appreciated that many further combinations and permutations of the subject innovation are possible. Accordingly, the claimed subject matter is intended to embrace all such alterations, modifications, and variations that fall within the spirit and scope of the appended claims. Moreover, the above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize. In addition, while a particular feature of the subject innovation may have been disclosed with respect to only one of several implementations, such feature may be combined with one or more other features of the other implementations as may be desired and advantageous for any given or particular application.

One or more components may reside within a process and/or thread of execution and a component may be localized on one computer and/or distributed between two or more computers. Further, a “device” can come in the form of specially designed hardware; generalized hardware made specialized by the execution of software thereon that enables the hardware to perform specific function; software stored on a computer readable medium; or a combination thereof. The words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

The foregoing description, for purpose of explanation, has been described with reference to specific implementations. However, the illustrative discussions above are not intended to be exhaustive or to limit the disclosed subject matter to the precise forms disclosed. Many modifications and variations are possible in view of the above teachings. The implementations were chosen and described in order to explain the principles of the disclosed subject matter and their practical applications, to thereby enable others skilled in the art to utilize those implementations as well as various implementations with various modifications as may be suited to the particular use contemplated.

1. A method for providing an application to a user device, comprising:
providing a remote application use to a user device;
receiving notification of a background installation of a native application corresponding to the remote application on the user device during the remote application use;
identifying data of the remote application use and replicating data of the remote application use on the user device; and
transitioning the user device from the remote application use to a native application operation executed by the replicated data at the native application on the user device.

2. The method of claim 1, further comprising automatically providing the remote application use in response to a search performed by a user of the user device, wherein the remote application use is a web-based application implementation of an application identified by the search.

3. The method of claim 1, further comprising automatically providing the remote application use in response to a search performed by a user of the user device, wherein the remote application use is a cloud-based application emulation of an application identified by the search.

4. The method of claim 1, further comprising transitioning the user device from the remote application use to a native application operation on the user device when a display screen is reloaded on the user device during the remote application use.

5. The method of claim 1, wherein the step of identifying data of the remote application use comprises monitoring the remote application use by the user device and identifying data associated with the remote application use.

6. The method of claim 5, wherein the step of replicating data of the remote application use comprises communicating identified data associated with the remote application use to the user device as a binary file for execution of the native application operation on the user device using the communicated data.

7. A non-transitory computer-readable storage medium containing instructions that, when executed, control a device to be configured for:
providing a remote application use to a user device;
receiving notification of a background installation of a native application corresponding to the remote application on the user device during the remote application use;
identifying data of the remote application use and replicating data of the remote application use on the user device; and
transitioning the user device from the remote application use to a native application operation executed by the replicated data at the native application on the user device.

8. The non-transitory computer-readable storage medium of claim 7, further containing instructions that, when executed, control the device to be configured for automatically providing the remote application use in response to a search performed by a user of the user device, wherein the remote application use is a web-based application implementation of an application identified by the search.

9. The non-transitory computer-readable storage medium of claim 7, further containing instructions that, when executed, control the device to be configured for automatically providing the remote application use in response to a search performed by a user of the user device, wherein the remote application use is a cloud-based application emulation of an application identified by the search.

10. The non-transitory computer-readable storage medium of claim 1, further containing instructions that, when executed, control the device to be configured for transitioning the user device from the remote application use to a native application operation on the user device when a display screen is reloaded on the user device during the remote application use.

11. The non-transitory computer-readable storage medium of claim 7, further containing instructions that, when executed, control the device to be configured for monitoring the remote application use by the user device and identifying data associated with the remote application use.

12. The non-transitory computer-readable storage medium of claim 11, further containing instructions that, when executed, control the device to be configured for communicating identified data associated with the remote application use to the user device as a binary file for execution of the native application operation on the user device using the communicated data.

13. A system for providing an application to a user device, comprising:
a manager configured to provide a remote application use to a first user device and receive notification of a background installation of a native application corresponding to the remote application on the first user device during the remote application use, and identify data of the remote application use; and
a communication element configured to replicate data of the remote application use on the first user device,
wherein the manager is further configured to transition the first user device from the remote application use to a native application operation executed by the replicated data at the native application on the first user device.

14. The system of claim 13, further comprising a distribution server configured to store applications for search and access by the user.

15. The system of claim 14, wherein the manager is further configured to provide the remote application use in response to a search performed by a user of the first user device, wherein the remote application use is a web-based application implementation of an application identified by the search.

16. The system of claim 14, wherein the manager is further configured to provide the remote application use in response to a search performed by a user of the first user device, wherein the remote application use is a cloud-based application emulation of an application identified by the search.

17. The system of claim 13, wherein the manager is further configured to transition the first user device from the remote application use to a native application operation on the first user device when a display screen is reloaded on the first user device during the remote application use.

18. The system of claim 13, wherein the manager is further configured to monitor the remote application use by the first user device and identify data associated with the remote application use.

19. The system of claim 18, wherein the communication element is further configured to communicate identified data associated with the remote application use to the first user device as a binary file for execution of the native application operation on the first user device using the communicated data.

20. The system of claim 18, wherein the communication element is further configured to communicate identified data associated with the remote application use to a second user device as a binary file for execution of the native application operation on the second user device using the communicated data.
